(19) United States
(12) Patent Application Publication
(10) Pub. No.: US 2008/0024591 A1
(43) Pub. Date: Jan. 31, 2008

(54) Wireless communication system, wireless communication apparatus, and computer readable medium storing wireless information setting program

(75) Inventors: Hiroshi Doi, Saitama (JP); Hiroshi Shiraku, Saitama (JP); Makoto Oshiumi, Saitama (JP); Yoshihito Oono, Saitama (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 11/714,726

(22) Filed: Mar. 7, 2007

(30) Foreign Application Priority Data
Jul. 28, 2006 (JP) 2006-206401

(51) Int. Cl. H04N 7/14

(52) U.S. Cl. 348/14.01

(57) ABSTRACT

A wireless communication system comprises a base station, and a wireless communication apparatus performing wireless communications with the base station, wherein the wireless communication apparatus comprises a communication unit that performs wireless communications with the base station and wireless communications between apparatuses without involving the base station; a storage unit that stores setting information used by the communication unit for wireless communications with the base station; a detector that detects whether of not there is a communicable object apparatus in a range where the communication unit is able to perform wireless communications between apparatuses; and a transmitter that transmits the setting information stored in the storage unit to the object apparatus detected by the detector via the communication unit.

### CROSS-REFERENCE TO RELATED APPLICATIONS

This application is based on and claims priority under 35 USC 119 from Japanese Patent Application No. 2006-206401.

### BACKGROUND OF THE INVENTION

1. Field of the Invention

The present invention relates to a wireless communication system, a wireless communication apparatus, and a computer readable medium storing a wireless information setting program.

2. Description of the Related Art

In recent years, there have been increased opportunities to use wireless communications employing radio waves or the like. For example, various apparatuses capable of communications with a wireless access point operating as a base station (hereafter referred to as the “wireless AP”) have been proposed. These apparatuses include devices such as personal computers, printers, scanners, and hard disk drives.

The wireless AP often operates as a switch that constitutes a network in which computers are used. Through the wireless AP, a network can be formed, and a wired network can be connected in many cases as well.

Meanwhile, in wireless communications between a wireless AP and various apparatuses, an ESS-ID (Extended Service Set Identifier) or WEP (Wired Equivalent Privacy) key is generally used as identification information. This makes it necessary to set such identification information as wireless setting information not only in the wireless AP but also in other wireless communication apparatuses including equipment communicating with the wireless AP.

### SUMMARY OF THE INVENTION

According to an aspect of the present invention, there is provided a wireless communication system comprising a first wireless communication apparatus and a second wireless communication apparatus that perform communications in a first communication method in which preset setting information is used and in a second communication method in which the setting information is not used, the first wireless communication apparatus comprising a communication unit that performs wireless communications in the first and second communication methods; a storage unit that stores the setting information; a detector that detects the second wireless communication apparatus by causing the communication unit to perform wireless communications in the second communication method; and a transmitter that transmits the setting information stored in the storage unit to the second wireless communication apparatus by causing the communication unit to perform wireless communications in the second communication method, the second wireless communication apparatus comprising a communication unit that performs wireless communications in the first and second communication methods; a receiver that receives setting information from the first wireless communication apparatus by causing the communication unit to perform wireless communications in the second communication method; and a setting unit that sets the setting information received by the receiver as setting information used for communication by the first communication method.

### BRIEF DESCRIPTION OF THE DRAWINGS

Exemplary embodiments of the present invention will be described in detail based on the following figures, wherein:

FIG. 1 is a diagram illustrating a situation in which wireless setting information is set in a newly installed printer according to an exemplary embodiment 1;

FIG. 2 is a block diagram illustrating configuration of a printer 101 and a printer 105;

FIG. 3 is a flowchart illustrating the flow of operations of the printer 101 and the printer 105;

FIG. 4 is a diagram illustrating the flow of information transmitted and received by the printer 101 and the printer 105;

FIGS. 5A to 5C are diagrams illustrating an example of a method of transmitting a detection signal, a response signal, and wireless setting information, respectively;

FIG. 6 is a block diagram illustrating configuration of a printer 201 and a printer 205;

FIG. 7 is a flowchart illustrating the flow of operations of the printer 101 according to an exemplary embodiment 3;

FIG. 8 is a diagram illustrating a situation in which wireless setting information is set in a newly installed printer according to an exemplary embodiment 4;

FIG. 9 is a block diagram illustrating configuration of a printer 401;

FIG. 10 is a flowchart illustrating the flow of operations of the printer 401 and a printer 406;

FIG. 11 is a diagram illustrating the flow of information transmitted and received by the printer 401 and the printer 406;

FIG. 12 is a diagram illustrating a situation in which wireless setting information is set in a newly installed printer according to an exemplary embodiment 5;

FIG. 13 is a bloc diagram illustrating configuration of a wireless AP 501;

FIG. 14 is a flowchart illustrating the flow of operations of the wireless AP 501 and a printer 506;

FIG. 15 is a diagram illustrating the flow of information transmitted and received by the wireless AP 501 and the printer 506;

FIGS. 16A and 16B are diagrams illustrating an example of a detection signal receivable in the ad-hoc mode;

FIG. 17 is a block diagram illustrating configuration of a printer 606; and

FIG. 18 is a flowchart illustrating the flow of operations of the wireless AP 501 and the printer 606.

### DETAILED DESCRIPTION

A wireless communication apparatus, a wireless communication system, and a computer readable medium storing a wireless information setting program according to an aspect of the present invention will be described in detail with reference to the accompanying drawings.

### Exemplary Embodiment 1

An exemplary embodiment 1 described below relates to an example in which wireless setting information is set in a newly installed printer by the operations of a printer already in operation and the newly installed printer. Although, in the description below, a printer is used as an apparatus performing wireless communication, other apparatuses such as a scanner or a disk drive may be used as the apparatus performing wireless communication.

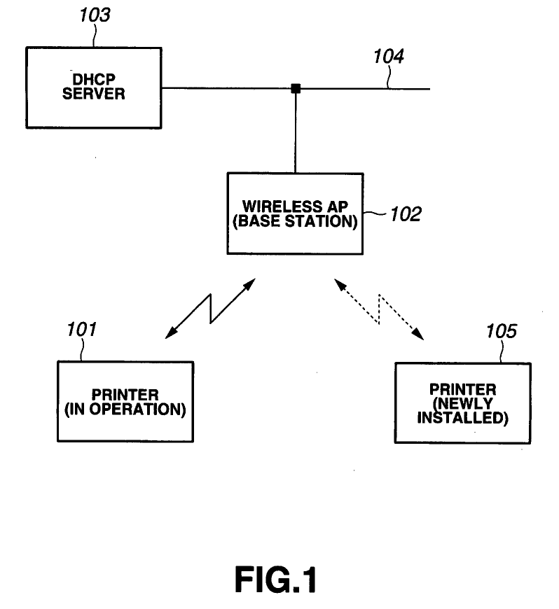

FIG. 1 is a diagram illustrating a situation in which wireless setting information is set in a newly installed printer. Specifically, FIG. 1 shows a case in which a printer 105 is newly installed in a system composed of a printer 101, a wireless AP 102, a DHCP server 103, and a network 104. The system shown in FIG. 1 is only a part thereof, and other apparatuses, not shown, are connected to the system via the network 104.

The printer 101 is a printer already in operation in the system and performs wireless communications with the wireless AP 102 operating as a base station. The wireless communications between the printer 101 and the wireless AP 102 is a communication method referred to as the infrastructure mode which is capable of one-to-many communication. This communication method is often used for communication between apparatuses via the wireless AP. Therefore, there is set in the printer 101 wireless setting information including identification information such as ESS-ID and a WEP key required for performing wireless communications with the wireless AP 102 in the infrastructure mode.

The wireless AP 102, which performs wireless communications with a plurality of apparatuses in the infrastructure mode, is also connected to the network 104.

The DHCP server 103 assigns network information such as an address to the apparatuses connected on the network 104, using DHCP (Dynamic Host Configuration Protocol) as a protocol, for example.

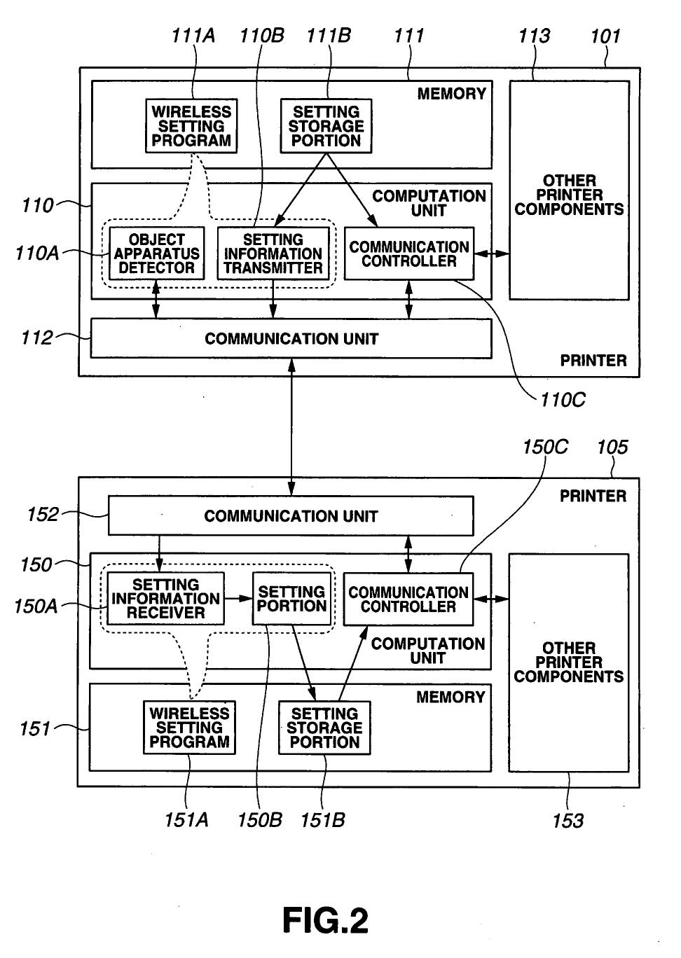

A description will be made of the printer 101 and the printer 105. FIG. 2 is a block diagram illustrating configuration of the printer 101 and the printer 105.

As shown in FIG. 2, the printer 101 has a computation unit 110, a memory 111, a communication unit 112, and other printer components 113. The computation unit 110 is for performing computation processing, and is realized by a processor such as a CPU (Central Processing Unit). The memory 111 is for storing information or the like, and is realized by a memory such as an ROM (Read Only Memory), an RAM (Random Access Memory), and a nonvolatile memory (Nonvolatile Memory), or a magnetic disk. The communication unit 112 is for performing wireless communications with the wireless AP 102 or the printer 105, and includes an antenna and a transmitting/receiving circuit, etc. The other printer components 113 include general components and parts constituting the printer.

The memory 111 stores at least a wireless setting program 111A. Additionally, a storage area to be used as a setting storage portion 111B is secured in the memory 111. The setting storage portion 111B stores at least wireless setting information to be used by the printer 101 to perform wireless communications with the wireless AP 102 in the infrastructure mode.

The computation unit 110 executes at least the wireless setting program 111A stored in the memory 111 to thereby realize an object apparatus detector 110A and a setting information transmitter 110B. The computation unit 110 further executes other programs (not shown) stored in the memory 111 to thereby realize a communication controller 110C. The object apparatus detector 110A is for detecting an object apparatus to set the wireless setting information therein. The setting information transmitter 110B transmits the wireless setting information stored in the setting storage portion 111B to the apparatus detected by the object apparatus detector 111A. The communication controller 110C is for controlling wireless communications performed by the communication unit 112. When the wireless communications is performed with the wireless AP 102 in the infrastructure mode, the communication controller 110C utilizes the wireless setting information stored in the setting storage portion 111B. The communication controller 110C also controls wireless communications performed by the communication unit 112 by a communication method referred to as the ad-hoc mode that is capable of one-to-one communication and is often used when communication is performed between apparatuses without involving a wireless AP. The wireless setting program 111A and other programs stroked in the memory 111 can be provided not only by being stored in various types of memories or storage media such as an optical disk, but also by distribution via a communication circuit.

The printer 105 has a computation unit 150, a memory 151, a communication unit 152, and other printer components 153. The computation unit 150 is for performing computation processing, and is realized by a processor such as a CPU. The memory 151 is for storing information or the like, and is realized by a memory such as an ROM, an RAM and a nonvolatile memory, or a magnetic disk. The communication unit 152 is for performing wireless communications with the wireless AP 102 and the printer 101, etc. and includes an antenna and a transmitting/receiving circuit, etc. The other printer components 153 include general components and parts constituting a printer.

The memory 151 stores at least a wireless setting program 151A. Additionally, a storage area to be used as a setting storage portion 151B is secured in the memory 111.

The computation unit 150 executes at least the wireless setting program 151A stored in the memory 151 to thereby realize a setting information receiving portion 150A and a setting portion 150B. Further, the computation unit 150 executes other programs (not shown) stored in the memory 151 to thereby realize a communication controller 150C. The setting information receiving portion 150A receives wireless setting information used by the computation unit 150 when performing wireless communications with the wireless AP 102 in the infrastructure mode. The setting portion 150B performs setting based on the wireless setting information received by the setting information receiving portion 150A, and stores the wireless setting information in the setting storage portion 151B. The communication controller 150C controls wireless communications performed by the communication unit 152. When the communication unit 152 performs wireless communications with the wireless AP 102 in the infrastructure mode, the communication controller 150C uses the wireless setting information stored in the setting storage portion 151B. The communication controller 150C also controls wireless communications performed by the communication unit 152 in the ad-hoc mode. The wireless setting program 151A and other programs stored in the memory 111 can be provided not only by being stored in various types of memories or storage media such as an optical disk, but also by distribution via a communication circuit.

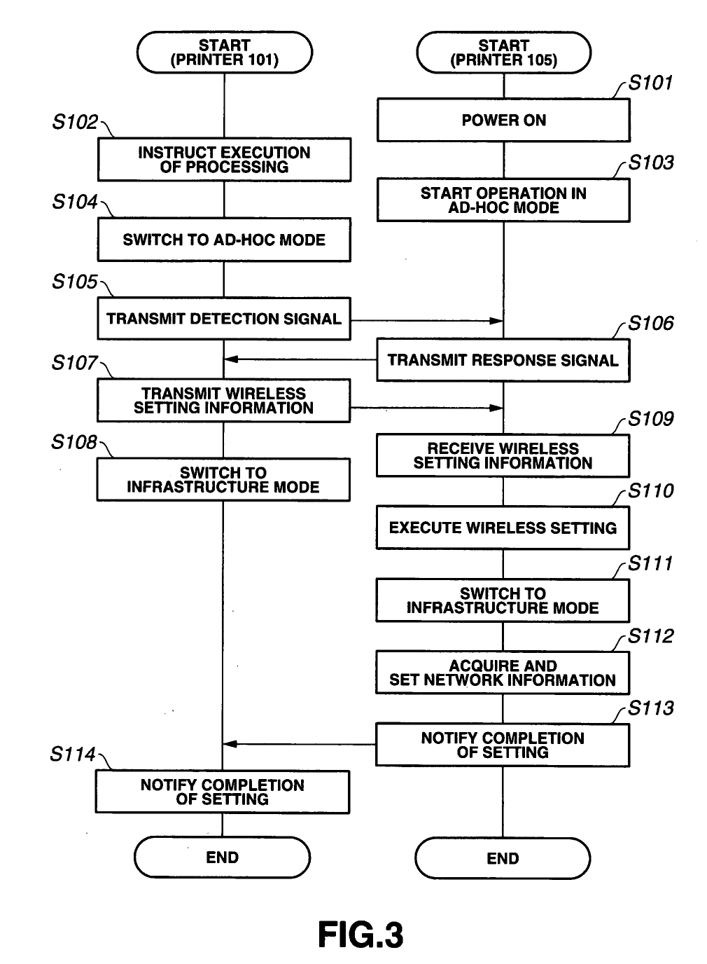

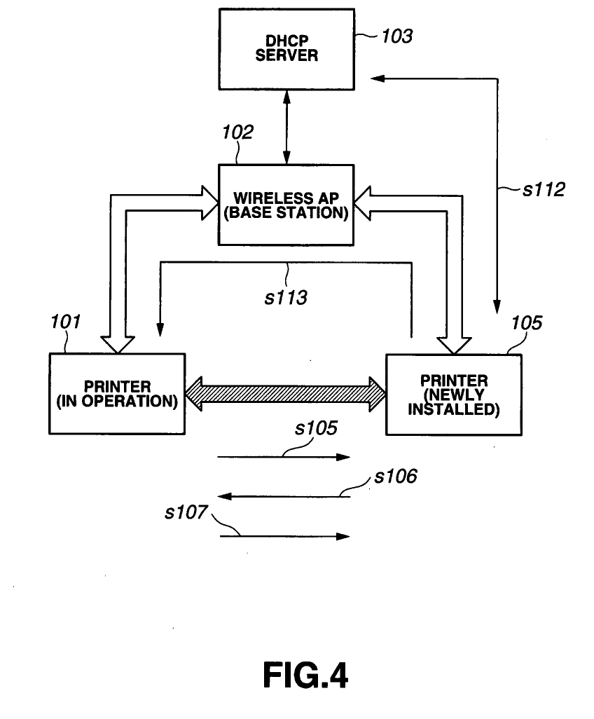

A description will be made of operation of the printer 101 and the printer 105. FIG. 3 is a flowchart illustrating the flow of the operations of the printer 101 and the printer 105, while FIG. 4 illustrates the flow of information transmitted and received by the printer 101 and the printer 105.

The printer 101 and the printer 105 start operating when a person installing the printer 105 (a manager or user) installs the printer 105 in the vicinity of the printer 101 (in a range capable of wireless communication), turns on power to the printer 105 (S101), and gives instruction to start the setting processing by means of an operation unit (not shown) of the printer 101 (S102).

Upon power being turned on to the printer 105, the communication controller 150C causes the communication unit 152 to start wireless communications in the ad-hoc mode since no wireless setting information is stored in the setting storage portion 151B (S103).

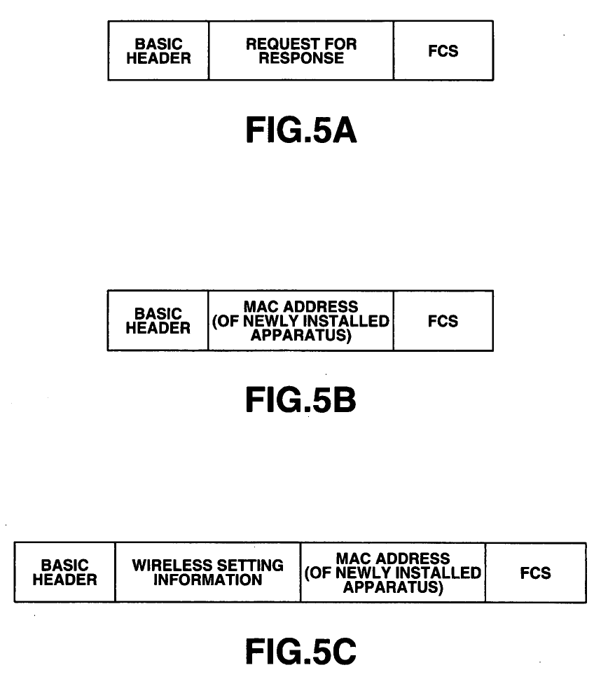

On the other hand, on the side of the printer 101, the communication controller 150C switches the wireless communications by the communication unit 112 from the infrastructure mode to the ad-hoc mode upon being instructed to start the setting processing, (S104). When the wireless communications by the communication unit 112 is switched to the ad-hoc mode, the object apparatus detector 110A transmits a detection signal for detecting an object apparatus (S105, S105 in FIG. 4). As shown in FIG. 5A, for example, this detection signal is composed of a basic header, a response request requesting a wireless communication apparatus receiving the detection signal for a response, and an FCS (Frame Check Sequence) that is a set of bits used to check for errors.

Upon the printer 101 transmitting a detection signal, the communication controller 150C of the printer 105 receives the detection signal via the communication unit 152, and transmits a response signal to the printer 101 (S106, s106). As shown in FIG. 5B, for example, this response signal is composed of a basic header, an MAC (Media Access Control) address preliminarily assigned to the communication unit 152C, and an FCS.

When the printer 105 transmits the response signal to the printer 101 and the printer 101 receives this, the setting information transmitter 110B of the printer 101 transmits wireless setting information stored in the setting storage portion 111B to the printer 105 (S107, s107). As shown in FIG. 5C, for example, the wireless setting information is transmitted together with a basic header, an MAC address of the communication unit 152C, and an FCS. Upon transmitting the wireless setting information, the communication controller 110C of the printer 101 switches the wireless communications performed by the communication unit 112 from the ad-hoc mode to the infrastructure mode (S108).

Upon the setting information receiving portion 150A of the printer 105 receiving the wireless setting information via the communication unit 152 (S109), the setting portion 150B of the printer 105 performs setting based on the received wireless setting information and stores the wireless setting information in the setting storage portion 151B (S110).

Subsequently, the communication controller 150C of the printer 105 switches the wireless communications by the communication unit 152 from the ad-hoc mode to the infrastructure mode (S111), and the printer 105 performs communication with the DHCP server 103 via the wireless AP 102 to acquire and set network information such as an address (S112, S112). The printer 105 then notifies the printer 101 via the wireless AP 102 of completion of setting as an apparatus connected on the network 104 (S113), and terminates the setting processing.

Upon receiving the notification of completion of setting from the printer 105, the printer 101 causes the operation unit (not shown) to display the message of completion of setting to notify the person installing the printer 105 of the completion of setting (S114), and terminates the setting processing.

If the printer 101 receives no response signal in response to the detection signal transmitted in the step S105, the communication controller 110C switches the wireless communications by the communication unit 112 from the ad-hoc mode to the infrastructure mode, causes the operation unit (not shown) to display a message that no object apparatus is detected, and terminates the setting processing.

When the printer 105 to be installed is a printer that has been connected and used on a different network, the wireless setting information can be changed by initializing the setting of the printer 105 to delete the wireless setting information stored in the setting storage portion 151B before similar processing is performed.

### Exemplary Embodiment 2

An exemplary embodiment 2 relates to an example in which configuration of printers are different from that described in the exemplary embodiment 1. A situation in which wireless setting information is set according to the exemplary embodiment 2 is the same as the situation in which the printer 101 and the printer 105 in FIG. 1 are replaced with a printer 201 and a printer 205, respectively. Although the description below will be made for the case where an apparatus which performs wireless communications is a printer, other apparatuses such as a scanner or a disk drive may be used as the apparatus performing wireless communication.

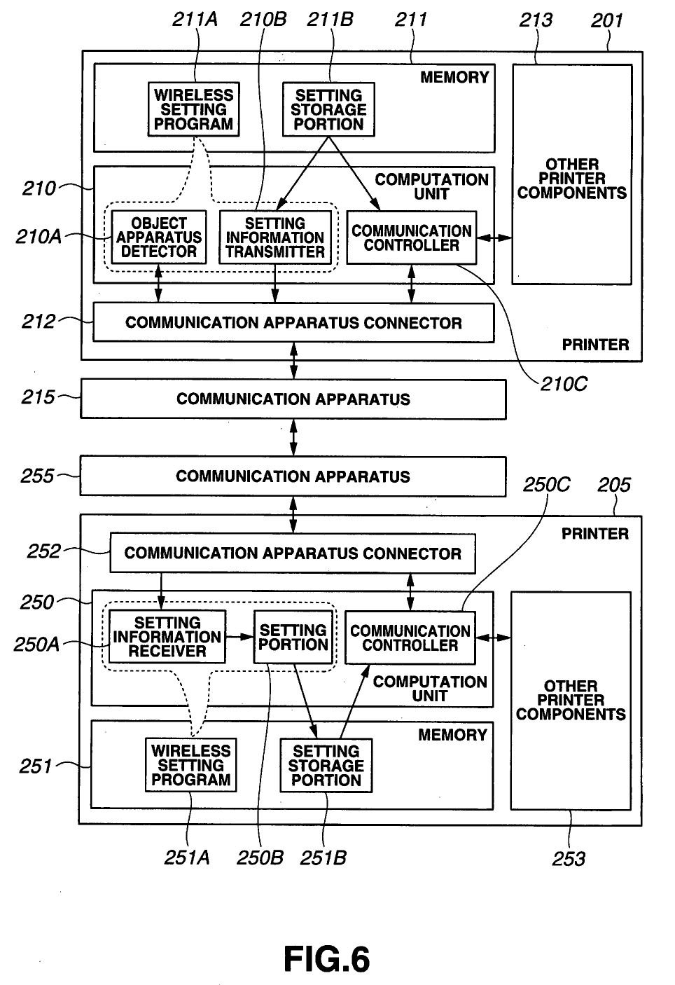

A description will be made of the printer 201 and the printer 205. FIG. 6 is a block diagram illustrating configuration of the printer 201 and the printer 205.

As shown in FIG. 6, the printer 201 has a computation unit 210, a memory 211, a communication apparatus connector 212, and other printer components 213. The computation unit 210 performs computation processing and is realized by a processor such as a CPU. The memory 211 stores information or the like, and is realized by a memory such as an ROM, an RAM, and a nonvolatile memory, or a magnetic disk. The communication apparatus connector 212 is connected to a communication apparatus 215, and uses a USB (Universal Serial Bus) for example as an interface. The other printer components 213 include general components and parts constituting a printer. The communication apparatus 215 performs wireless communications with the wireless AP 102 or the printer 205, and includes an antenna and a transmitting/receiving circuit, etc.

The memory 211 stores at least a wireless setting program 211A and a storage area is secured to be used as a setting storage portion 211B. The setting storage portion 211B stores at least wireless setting information used by the printer 201 to perform wireless communications with the wireless AP 102 in the infrastructure mode.

The computation unit 210 executes at least the wireless setting program 211A stored in the memory 211 to thereby realize an object apparatus detector 210A and a setting information transmitter 210B. The computation unit 210 executes other programs (not shown) stored in the memory 211 to thereby realize a communication controller 210C. The object apparatus detector 210A detects an object apparatus to set wireless setting information therein. The setting information transmitter 210B transmits wireless setting information stored in the setting storage portion 211B to the apparatus detected by the object apparatus detector 210A. The communication controller 210C controls wireless communications performed by the communication apparatus 215 connected to the communication apparatus connector 212. When the wireless communications is performed with the wireless AP 102 in the infrastructure mode, the communication controller 210C utilizes the wireless setting information stored in the setting storage portion 211B. The communication controller 210C also controls one-to-one wireless communications referred to as the ad-hoc mode performed by the communication apparatus 215 connected to the communication apparatus connector 212.

The wireless setting program 211A and other programs stored in the memory 211 can be provided by being stored in various types of memories or storage media such as an optical disk, or by distribution via a communication circuit.

On the other hand, the printer 205 has a computation unit 250, a memory 251, a communication unit 252, and other printer components 253. The computation unit 250 performs computation processing, and is realized by a processor such as a CPU, for example. The memory 251 stores information or the like, and is realized by a memory such as an ROM, an RAM and a nonvolatile memory, or a magnetic disk. The communication apparatus connector 252 is connected to a communication apparatus 255 and uses a USB as an interface, for example. The other printer components 253 include general components and parts constituting a printer. The communication apparatus 255 performs wireless communications with the wireless AP 102 and the printer 201 and includes an antenna and a transmitting/receiving circuit, etc.

The memory 251 at least stores a wireless setting program 251A, and a storage area to be used as a setting storage portion 251B is secured in the memory 251.

The computation unit 250 executes at least the wireless setting program 251A stored in the memory 251 to thereby realize a setting information receiving portion 250A and a setting portion 250B. The computation unit 250 executes other programs (not shown) stored in the memory 251 to thereby realize a communication controller 250C. The setting information receiving portion 250A receives wireless setting information that is used when wireless communications is performed with the wireless AP 102 in the infrastructure mode. The setting portion 250B performs setting based on the wireless setting information received by the setting information receiving portion 250A, and stores the wireless setting information in the setting storage portion 251B. The communication controller 250C controls wireless communications performed by the communication apparatus 255 connected to the communication apparatus connector 252. When wireless communications is performed with the wireless AP 102 in the infrastructure mode, the communication controller 250C uses the wireless setting information stored in the setting storage portion 251B. The communication controller 250C also controls wireless communications performed by the communication apparatus 255 connected to the communication apparatus connector 252 in the ad-hoc mode. The wireless setting program 251A and other programs stored in the memory 251 can be provided by being stored in various types of memories or storage media such as an optical disk, or by distribution via a communication circuit.

Operation of the printer 201 and the printer 205 can be considered the same as in the exemplary embodiment 1 when the printer 101, the computation unit 110, the memory 111, and the other printer components 113, the wireless setting program 111A, the setting storage portion 111B, the object apparatus detector 111A, the setting information transmitter 110B, and the communication controller 110C in the exemplary embodiment 1 are replaced with the printer 201, the computation unit 210, the memory 211, the other printer components 213, the wireless setting program 211A, the setting storage portion 211B, the object apparatus detector 210A, the setting information transmitter 210B, and the communication controller 210C, respectively, while the communication unit 112 is replaced with the communication apparatus 215 connected to the communication apparatus connector 212, and the printer 151, the computation unit 150, the memory 151, the other printer components 153, the wireless setting program 151A, the setting storage portion 151B, the setting information receiving portion 150A, the setting portion 150B, and the communication controller 150C are replaced with the printer 251, the computation unit 250, the memory 251, the other printer components 253, the wireless setting program 251A, the setting storage portion 251B, the setting information receiving portion 250A, the setting portion 250B, and the communication controller 250C, respectively, while the communication unit 152 is replaced with the communication apparatus 255 connected to the communication apparatus connector 252. Therefore, the description of the operation of the printers 201 and 205 will be omitted.

It should be understood that the printer 101 described in the exemplary embodiment 1 may be combined with the printer 205 described in the exemplary embodiment 2 to perform setting of wireless setting information. Further, the printer 201 described in the exemplary embodiment 2 may be combined with the printer 105 described in the exemplary embodiment 1 to perform setting of wireless setting information. The operation in these cases is similar to the operation described above.

### Exemplary Embodiment 3

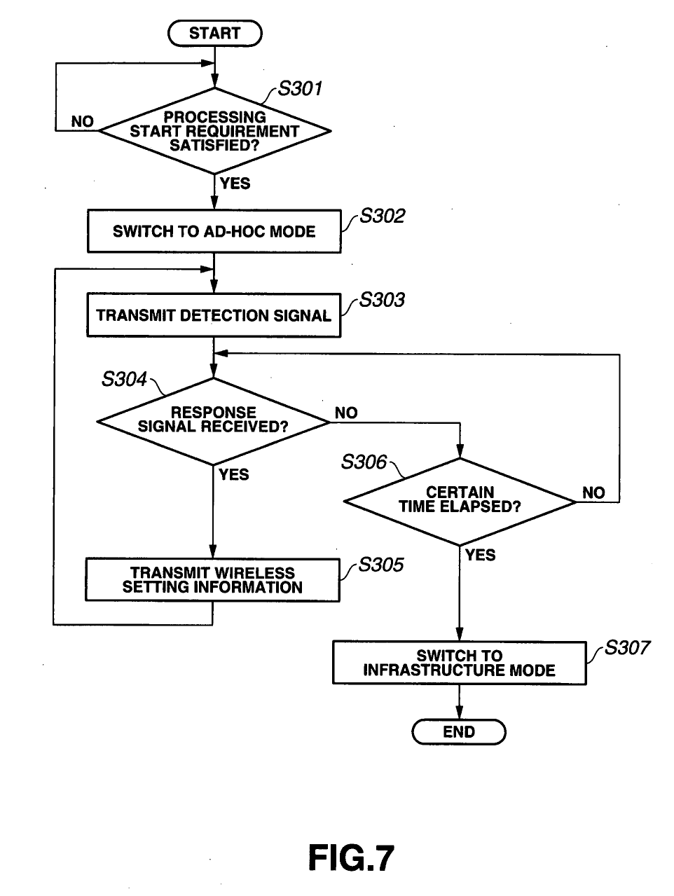

An exemplary embodiment 3 relates to a case in which operation of the printer 101 is different from that described in the exemplary embodiment 1. FIG. 7 is a flowchart illustrating the flow of operations of the printer 101 according to the exemplary embodiment 3.

The printer 101 and the printer 105 start operating when the printer 101 satisfies a requirement to start setting processing in the condition where a person installing the printer 105 (a manager or user) has installed the printer 105 in the vicinity of the printer 101 (in a range capable of wireless communication) and turned on power to the printer 105 (S301). The requirement for the printer 101 to start setting processing is, for example, the arrival to a predetermined time.

Upon the printer 101 starting the setting processing, the communication controller 110C switches wireless communications by the communication unit 112 from the infrastructure mode to the ad-hoc mode (S302). Once the wireless communications by the communication unit 112 is switched over to the ad-hoc mode, the object apparatus detector 110A transmits a detection signal for detecting an object apparatus (S303).

When the printer 105 transmits a response signal to the printer 101 in response to the detection signal (YES in S304) and the printer 101 receives this response signal, the setting information transmitter 110B of the printer 101 transmits wireless setting information stored in the setting storage portion 111B to the printer 105 (S305).

Upon transmitting the wireless setting information to the printer 105, the printer 101 returns to the processing of the step S303 and again transmits a detection signal. This processing is performed for coping with a case where a plurality of printers corresponding to the printer 105 are installed.

If a certain period of time has elapsed without the printer 101 having received a response signal in response to the transmitted detection signal (NO in S304 and YES in S306), the communication controller 110C switches the wireless communications performed by the communication unit 112 from the ad-hoc mode to the infrastructure mode, and the setting processing is terminated.

It should be understood that the printer 201 described in the exemplary embodiment 2 may also operate in the same manner as described in the exemplary embodiment 3.

### Exemplary Embodiment 4

An exemplary embodiment 4 relates to a case in which wireless setting information is set in a newly installed printer by the operations of a printer already in operation and the newly installed printer. Although the following description will be made for the case where an apparatus which performs wireless communications is a printer, other apparatuses such as a scanner or a disk drive may be used as an apparatus performing wireless communication.

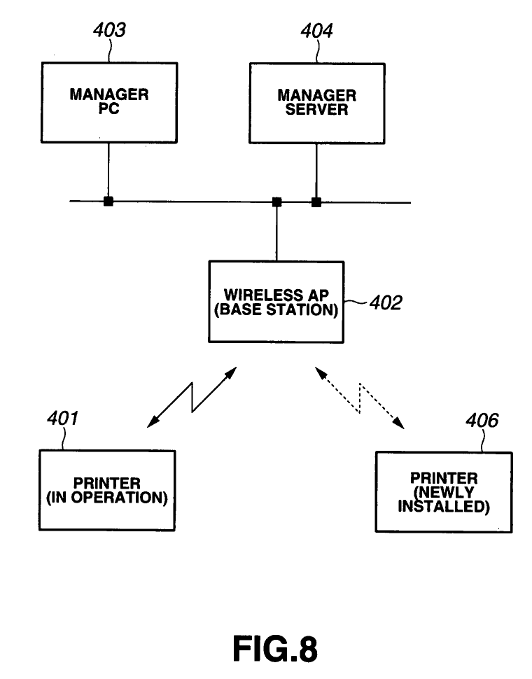

FIG. 8 is a diagram illustrating a situation in which wireless setting information is set in a newly installed printer. FIG. 8 shows a case in which a printer 406 is newly installed in a system composed of a printer 401, a wireless AP 402, a DHCP server 403, and a network 404. The system shown in FIG. 8 is only a part thereof, and other apparatuses, not shown, are connected to the system via the network 104. It will suffice if one of the manager PC 403 and the management server 404 is connected on the network 405, and the other one is not necessary (this does not always apply if the system is used for other purposes).

The printer 401 is a printer already operating in the system, and performs wireless communications with the wireless AP 402 operating as a base station. The wireless communications between the printer 401 and the wireless AP 402 is performed in the infrastructure mode. Therefore, wireless setting information, which is required for performing wireless communications with the wireless AP 402 in the infrastructure mode, is set in the printer 401.

The wireless AP 402 is connected on the network 405 and performs wireless communications with a plurality of apparatuses in the infrastructure mode.

The manager PC 403 is a personal computer used by a manager of the network 405.

The management server 404 manages the apparatuses connected on the network 405, and particularly manages network information such as addresses being used and addresses unused.

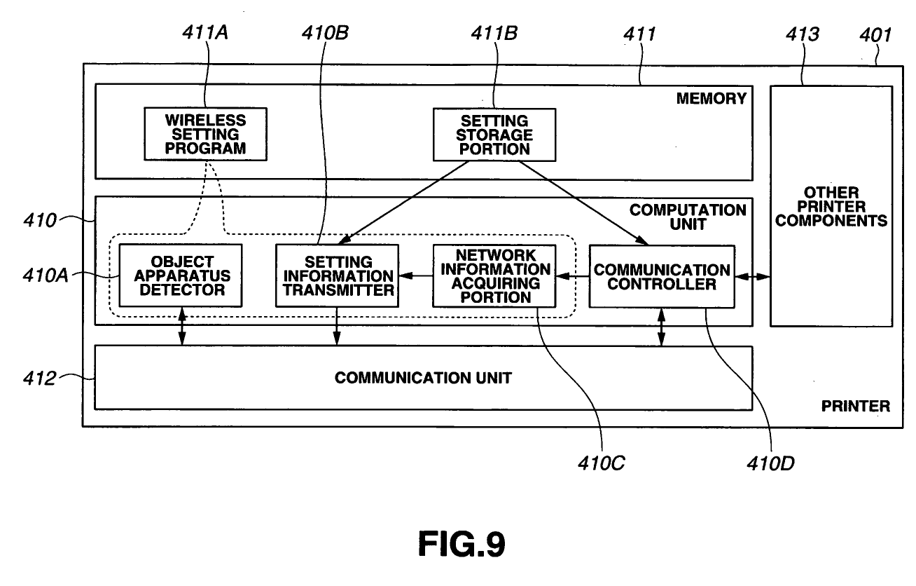

A description will be made of the printers 401 and 406. FIG. 9 illustrates configuration of the printer 401.

As shown in FIG. 9, the printer 401 has a computation unit 410, a memory 411, a communication unit 412, and other printer components 413. The computation unit 410 performs computation processing, and is realized by a processor such as a CPU, for example. The memory 411 stores information or the like, and is realized by a memory such as an ROM, RAM, and nonvolatile memory, or a magnetic disk. The communication unit 412 performs wireless communications with the wireless AP 402 and the printer 406, and includes an antenna, a transmitting/receiving circuit, etc. The other printer components 413 include general components and parts for constituting a printer.

The memory 411 stores at least a wireless setting program 411A, and a storage area to be used as a setting storage portion 411B is secured therein. The setting storage portion 411B stores at least wireless setting information used by the printer 401 to perform wireless communications with the wireless AP 402 in the infrastructure mode.

The computation unit 410 executes at least the wireless setting program 411A stored in the memory 411 to thereby realize an object apparatus detector 410A, a setting information transmitter 410B, and a network information acquiring portion 410C. The computation unit 410 executes other programs (not shown) stored in the memory 411 to thereby realize a communication controller 410D. The object apparatus detector 410A detects an object apparatus to set wireless setting information therein. The setting information transmitter 410B transmits wireless setting information stored in the setting storage portion 411B to the apparatus detected by the object apparatus detector 410A. The network information acquiring portion 410C acquires network information including an unused address from the manager PC 403 or the management server 404. The communication controller 410D controls wireless communications performed by the communication unit 412. When wireless communications is performed with the wireless AP 402 in the infrastructure mode, the communication controller 410D uses the wireless setting information stored in the setting storage portion 411B. The communication controller 410D also controls wireless communications performed by the communication unit 412 in the ad-hoc mode. The wireless setting program 411A and other programs stored in the memory 411 can be provided by being stored in various types of memories or storage media such as an optical disk, or by distribution via a communication circuit.

Since the printer 406 has similar configuration to that of the printer 105 described in the exemplary embodiment 1, the description thereof will be omitted.

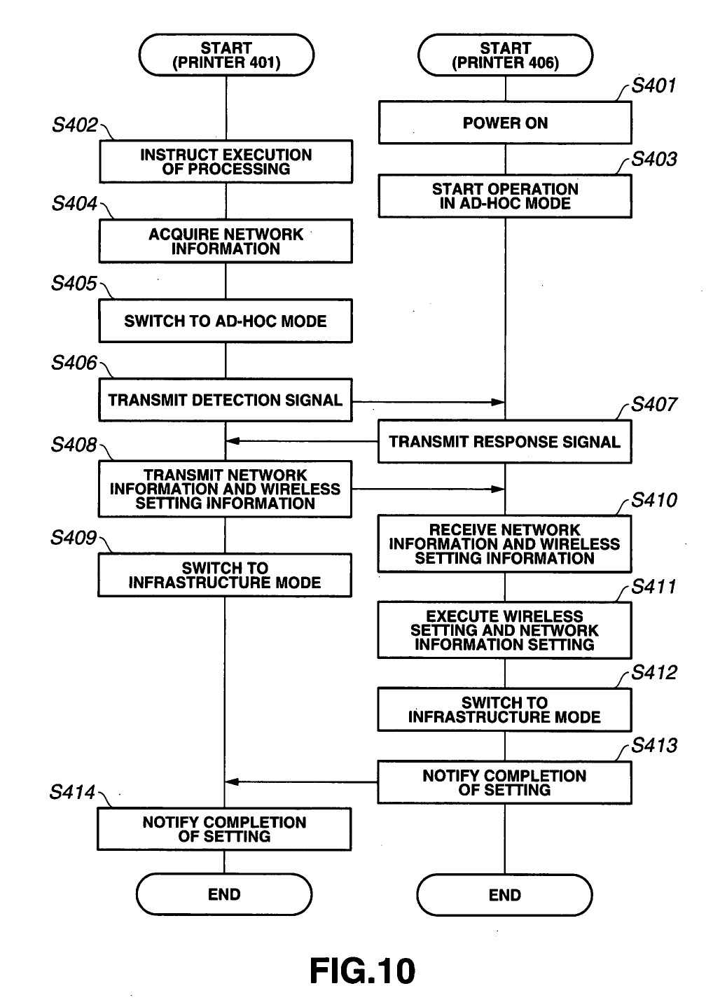

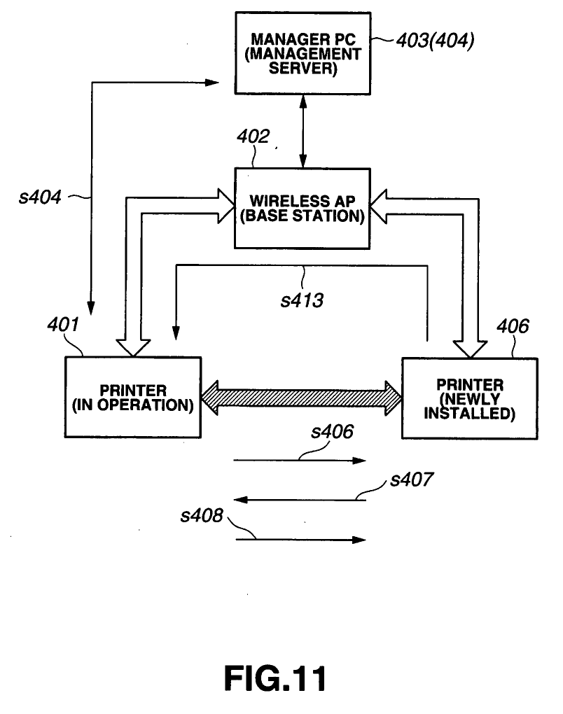

A description will be made of operation of the printer 401 and the printer 406. FIG. 10 is a flowchart illustrating the flow of operations of the printer 401 and the printer 406, while FIG. 11 illustrates the flow of information transmitted and received by the printer 401 and the printer 406. As described above, the printer 406 has similar configuration to that of the printer 105. Therefore, the following description of particulars of the printer 406 will be made with reference to FIG. 2.

The printer 401 and the printer 406 start operating when a person installing the printer 406 (a manager or user) installs the printer 406 in the vicinity of the printer 401 (in a range capable of wireless communication), turns on power to the printer 406 (S401), and gives instruction to start the setting processing by means of an operation unit (not shown) of the printer 401 (S402).

Upon power being turned on to the printer 406, the communication controller 150C of the printer 406 causes the communication unit 152 to start wireless communications in the ad-hoc mode since no wireless setting information is stored in the setting storage portion 151B (S403).

On the other hand, when instructed to start setting processing, the printer 401 is operating in the infrastructure mode, and thus the network information acquiring portion 410C acquires network information including an unused address from the manager PC 403 or the management server 404 (S404, s404 in FIG. 11). When network information is to be acquired from the manager PC 403, the manager is required to enter the network information through the manager PC 403, whereas when network information is to be acquired from the management server 404, the management server 404 gives a response automatically. When the manager enters the network information, the manager may enter the network information with the use of an operation unit (not shown) of the printer 401, instead of the manager PC 403.

Subsequently, the communication controller 410D of the printer 401 switches the wireless communications by the communication unit 412 from the infrastructure mode to the ad-hoc mode (S405). When the wireless communications performed by the communication unit 412 is switched to the ad-hoc mode, the object apparatus detector 410A transmits a detection signal for detecting an object apparatus (S406, s406). This detection signal is similar to that of the exemplary embodiment 1 (as shown in FIG. 5A, for example).

Upon the printer 401 transmitting a detection signal, the printer 406 receives this detection signal at the communication controller 150C through the communication unit 152 and transmits a response signal to the printer 401 (S407, s407). This response signal is similar to that of the exemplary embodiment 1 (as shown in FIG. 5B, for example).

Upon the printer 405 transmitting the response signal to the printer 401 and the printer 401 receiving this, the setting information transmitter 410B of the printer 401 transmits wireless setting information stored in the setting storage portion 411B and network information acquired by the network information acquiring portion 410C to the printer 406 (S408, s408). The wireless setting information and the network information are transmitted in a similar manner to the exemplary embodiment 1 (for example, by a signal in which the wireless setting information shown in FIG. 5C is replaced with the wireless setting information network information). After transmitting the wireless setting information, the communication controller 410D of the printer 401 switches wireless communications by the communication unit 412 from the ad-hoc mode to the infrastructure mode (S409).

On the other hand, upon the setting information receiving portion 150A of the printer 406 receiving the wireless setting information and the network information through the communication unit 152 (S410), the setting portion 150B performs setting based on the wireless setting information thus received, and stores the wireless setting information in the setting storage portion 151B while setting network information (S411).

The communication controller 150C of the printer 406 switches wireless communications performed by the communication unit 152 from the ad-hoc mode to the infrastructure mode (S412). The printer 406 then notifies the printer 401 of completion of the setting via the wireless AP 402, as an apparatus connected on the network 405 (S413), and terminates the setting processing.

Upon being notified of the completion of the setting by the printer 406, the printer 401 displays the message of completion of setting on the operation unit (not shown), to notify the person installing the printer 406 of the completion of setting (S414), and terminates the setting processing.

If the printer 401 does not receive a response signal in response to the detection signal transmitted in the step S406, the communication controller 410D switches the wireless communications performed by the communication unit 412 from the ad-hoc mode to the infrastructure mode, and displays on the operation unit a message indicating that an object apparatus cannot be detected (not shown), terminating the setting processing.

When a printer that has been used on a different network is installed as the printer 406, the wireless setting information can be changed by performing the processing as described above after initializing the setting of the printer to delete the wireless setting information stored in the setting storage portion 151B.

It is also possible to configure the printer 401 and the printer 406 so as to have a separate communication apparatus as described in the exemplary embodiment 2, or such that the printer 401 is activated when the processing start requirement is satisfied as described in the exemplary embodiment 3. Since these variations are conceivable to those skilled in the art, detailed description will be omitted.

### Exemplary Embodiment 5

An exemplary embodiment 5 relates to an example in which a wireless AP operating as a base station for wireless communications operates with a newly installed printer to thereby set wireless setting information in the newly installed printer. Although the description below is made with a printer used as an apparatus performing wireless communication, the apparatus performing wireless communications may be other types of apparatus, such as a scanner or a disk drive.

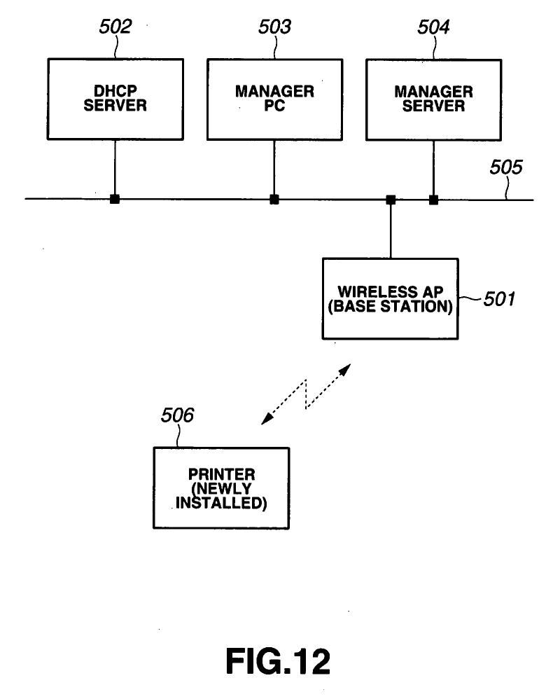

FIG. 12 is a diagram illustrating a situation in which wireless setting information is set in a newly installed printer. FIG. 12 relates to a case in which a printer 506 is newly installed in a system composed of a wireless AP 501, a DHCP server 502, a manager PC 503, a management server 504, and a network 505. The system shown here is only a part thereof and other apparatuses are connected to the system via the network 505. It suffices if any of the DHCP server 502, the manager PC 503, and the management server 504 is connected to the network 50, and no other is necessary. However, this is not applicable when the system is used for other purposes such as the manager approves a newly installed printer by using the manager PC 503.

The wireless AP 501 is connected to the network 505 and also performs wireless communications with a plurality of apparatuses in the infrastructure mode.

The DHCP server 502 assigns network information such as an address to apparatuses connected on the network 505, and uses DHCP as a protocol, for example.

The manager PC 503 is a personal computer used by the manager of the network 505.

The management server 504 manages the apparatuses connected on the network 505, and particularly manages network information such as used addresses and unused addresses.

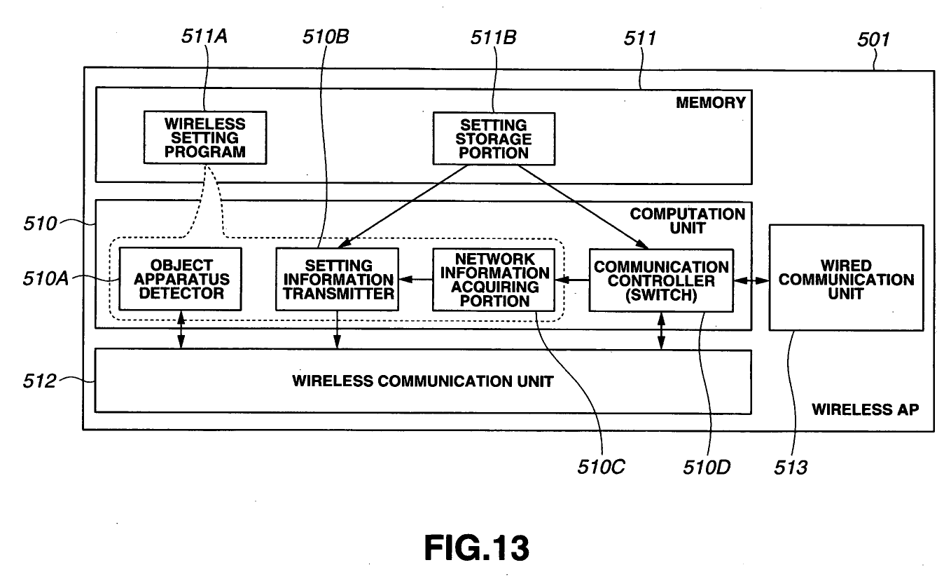

A description will be made of the wireless AP 501 and the printer 506. FIG. 13 is a block diagram illustrating configuration of the wireless AP 501.

As shown in FIG. 13, the wireless AP 501 has a computation unit 510, a memory 511, a wireless communication unit 512, and a wired communication unit 513. The computation unit 510 performs computation processing and is realized for example by a processor such as a CPU. The memory 511 stores information or the like, and is realized for example by a memory such as an ROM, RAM, and nonvolatile memory, or a magnetic disk or the like. The wireless communication unit 512 performs wireless communications with the printer 506 and the like, and includes an antenna and a transmitting/receiving circuit, etc. The wired communication unit 513 performs communication with the network 505 and includes a transmitting/receiving circuit, etc.

The memory 511 stores at least a wireless setting program 511A, and a storage area used as a setting storage portion 511B is secured therein. The setting storage portion 511B stores at least wireless setting information that is used by the wireless AP 501 to perform wireless communications in the infrastructure mode.

Further, the computation unit 510 at least executes the wireless setting program 511A stored in the memory 511 to thereby realize an object apparatus detector 510A, a setting information transmitter 510B, and a network information acquiring portion 510. The computation unit 510 also executes other programs (not shown) stored in the memory 511 to realize a communication controller 510D. The object apparatus detector 510A detects an object apparatus to set wireless setting information therein. The setting information transmitter 510B transmits the wireless setting information stored in the setting storage portion 511B to the apparatus detected by the object apparatus detector 510A. The network information acquiring portion 510C acquires network information including an unused address from the manager PC 503 or the management server 504. However, if the manager PC 503 and the management server 504 are not connected on the network 505 or not used, the network information acquiring portion 510C is not required. The communication controller 510D controls wireless communications performed by the wireless communication unit 512 and communication performed by the wired communication unit 513. The communication controller 510D operates as a repeater or a switch, while restricting the wireless communications if necessary. If the wireless communications is performed in the infrastructure mode, the communication controller 510D uses the wireless setting information stored in the setting storage portion 511B. The wireless setting program 511A and other programs stored in the memory 511 may be provided by being stored in various types of memories and storage media such as an optical disk, or by distribution via a communication circuit.

Since the printer 506 has similar configuration to that of the printer 105 described in the exemplary embodiment 1, description thereof will be omitted.

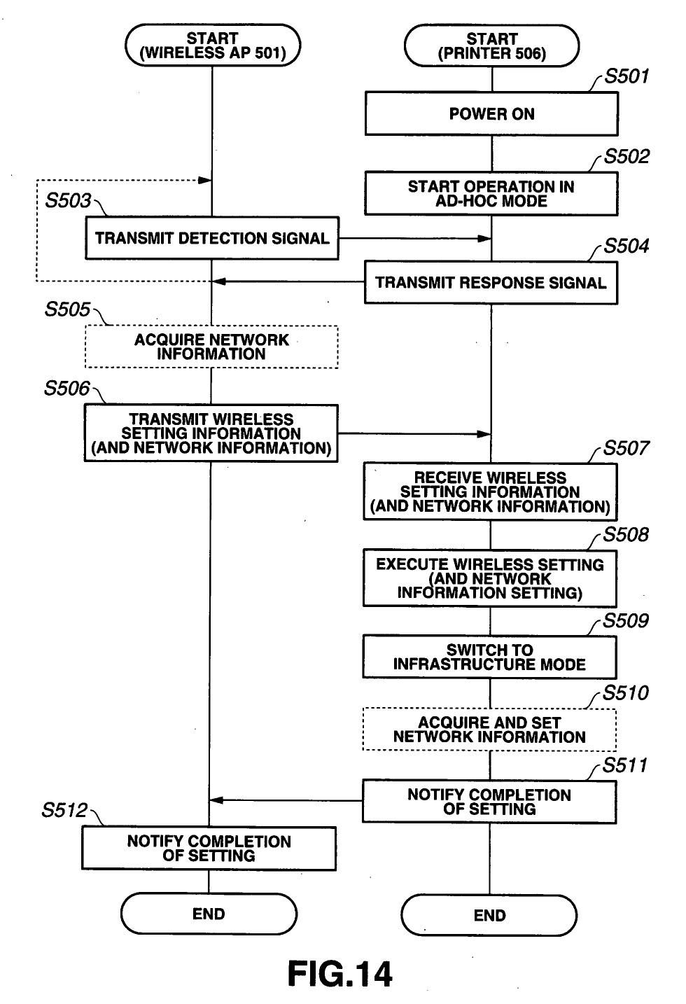

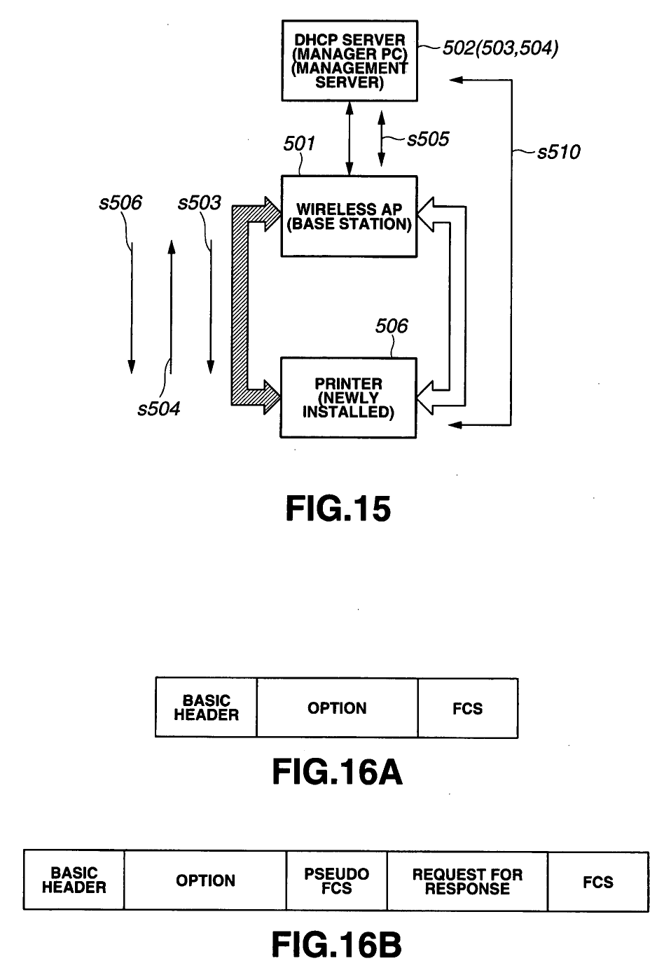

A description will be made of operation of the wireless AP 501 and the printer 506. FIG. 14 is a flowchart illustrating the flow of operations of the wireless AP 501 and the printer 506, while FIG. 15 is a diagram illustrating the flow of information transmitted and received by the wireless AP 501 and the printer 506. As mentioned before, since the printer 506 has similar configuration to that of the printer 105, description of particulars of the printer 506 will be made with reference to FIG. 2.

The wireless AP 501 and the printer 506 start operating when a person installing the printer 506 (the manager or user) arranges the printer 506 in the vicinity of the wireless AP 501 (in a range capable of wireless communication) and turns on power to the printer 506 (S501).

Upon power being turned on to the printer 506, the communication controller 150C causes the communication unit 152 to start wireless communications in the ad-hoc mode since no wireless setting information is stored in the setting storage portion 151B (S502).

On the other hand, the wireless AP 501, operating in the infrastructure mode, periodically transmits a detection signal that is receivable in the ad-hoc mode (S503, s503 in FIG. 15). This detection signal is, as shown in FIG. 16B, formed by adding a response request and a pseudo FCS to a standard signal as shown in FIG. 16A. The pseudo FCS has a value that is not valid as an FCS, and causes other apparatuses to discard the detection signal received.

Upon the wireless AP 501 transmitting a detection signal, the communication controller 150C of the printer 506 receives this detection signal through the communication unit 152, and transmits a response signal to the wireless AP 501 (S504, s504). This response signal is similar to that in the exemplary embodiment 1 (as shown in FIG. 5B, for example).

Upon the printer 506 transmitting a response signal to the wireless AP 501, the network information acquiring portion 510C of the wireless AP 501 acquires network information including an unused address from the manager PC 503 or the management server 504 (S505, s55). When network information is to be acquired from the manager PC 503, the manager is required to enter the network information through the manager PC 503. When network information is to be acquired from the management server 504, the management server 504 replies automatically. In the event of using the DHCP server 502 without using the manager PC 503 or the management server 504, however, the processing of the step S505 is not required.

Subsequently, the setting information transmitter 510B of the wireless AP 501 transmits wireless setting information stored in the setting storage portion 511B alone, or the wireless setting information and the network information acquired by the network information acquiring portion 510C together to the printer 506 (S506, s506). The wireless setting information is transmitted in a similar manner to the exemplary embodiment 1 or the exemplary embodiment 4 (as shown in FIG. 5C, for example). If the manager approves a newly installed printer with the use of the manager PC 503, the wireless AP 501, upon receiving a response signal, notifies the manager PC 503 of the reception thereof and requests approval for connection.

On the other hand, upon the setting information receiving portion 150A of the printer 506 receiving wireless setting information through the communication unit 152 (S507), the setting portion 150B performs setting based on the received wireless setting information, and stores the wireless setting information in the setting storage portion 151B, while setting network information (S508). However, if the DHCP server 502 is used without using the manager PC 503 or the management server 504, the setting of network information is not performed.

The communication controller 150C of the printer 506 then switches wireless communications performed by the communication unit 152 from the ad-hoc mode to the infrastructure mode (S509). The printer 506 then performs communication with the DHCP server 502 via the wireless AP 501 to acquire and set network information such as an address (S510, s510). However, when the manager PC 503 and the management server 504 are used without using the DHCP server 502, the processing of the step S510 is not necessary.

Subsequently, the printer 506 notifies the wireless AP 501 of completion of the setting as an apparatus connected on the network 505 (S511), and terminates the setting processing.

Upon being notified of completion of the setting by the printer 506, the wireless AP 501 acknowledges this notification (S512), and terminates the setting processing. At the same time, the wireless AP 501 may also notify the manager that the wireless AP 501 has been notified of completion of the setting by the printer 506.

When a printer that has been connected and used on a different network is installed as the printer 506, the wireless setting information can be changed by performing the processing as described above after initializing the setting of the printer 506 to delete the wireless setting information stored in the setting storage portion 151B.

It is also possible to configure the printer 406 so as to have a separate communication apparatus as described in the exemplary embodiment 2. Since this variation is conceivable to those skilled in the art, detailed description will be omitted.

### Exemplary Embodiment 6

An exemplary embodiment 6 described below relates to an example in which wireless setting information is set in a newly installed printer by the operations of the newly installed printer and a wireless AP serving as a base station for wireless communication. Although the description below is made with a printer used as an apparatus performing wireless communication, the apparatus performing wireless communications may be other types of apparatus, such as a scanner or a disk drive.

The situation for setting wireless setting information in the exemplary embodiment 6 is similar to the situation shown in FIG. 12 relating to the exemplary embodiment 5 but replaced the printer 506 with a printer 606. The wireless AP 501 of the exemplary embodiment 6 is partially different in operation from that of the exemplary embodiment 5.

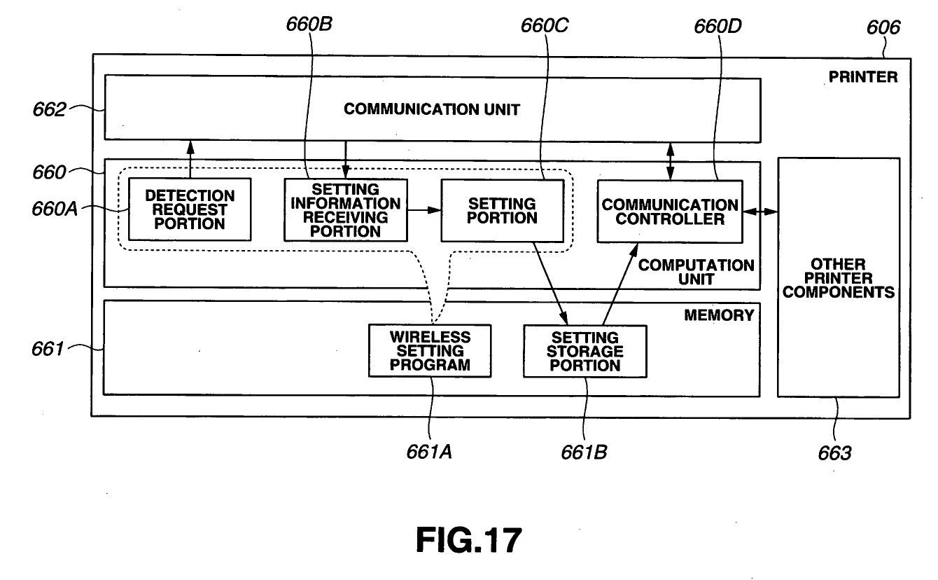

FIG. 17 is a block diagram illustrating configuration of the printer 606.

As shown in FIG. 17, the printer 606 has a computation unit 660, a memory 661, a communication unit 662, and other printer components 663. The computation unit 660 performs computation processing and is realized for example by a processor such as a CPU. The memory 661 stores information or the like, and is realized by a memory such as an ROM, RAM, and nonvolatile memory, or a magnetic disk. The communication unit 662 performs wireless communications with the wireless AP 501 and so on, and includes an antenna, a transmitting/receiving circuit, etc. The other printer components 663 include general components and parts constituting a printer.

The memory 661 stores at least a wireless setting program 661A, and a storage area used as a setting storage portion 661B is secured in the memory 661.

Further, the computation unit 660 executes at least the wireless setting program 661A stored in the memory 661 to thereby realize a detection request portion 660A, a setting information receiving portion 660B, and a setting portion 660C. The computation unit 660 executes other programs (not shown) stored in the memory 661 to thereby realize a communication controller 660D. The detection request portion 660A transmits to the wireless AP 501 a detection request signal for requesting detection. The setting information receiving portion 660B receives wireless setting information which is used when wireless communications with the wireless AP 50 is performed in the infrastructure mode. The setting portion 660C performs setting based on the wireless setting information received by the setting information receiving portion 660B, and stores the wireless setting information in the setting storage portion 661B. The communication controller 660D controls wireless communications performed by the communication unit 662. When the wireless communications with the wireless AP 501 is performed in the infrastructure mode, the communication controller 660D uses the wireless setting information stored in the setting storage portion 661B. The communication controller 660D also controls wireless communications performed by the communication unit 662 in the ad-hoc mode. The wireless setting program 661A and other programs stored in the memory 661 can be provided by various types of memories or storage media such as an optical disk, or by distribution through a communication circuit.

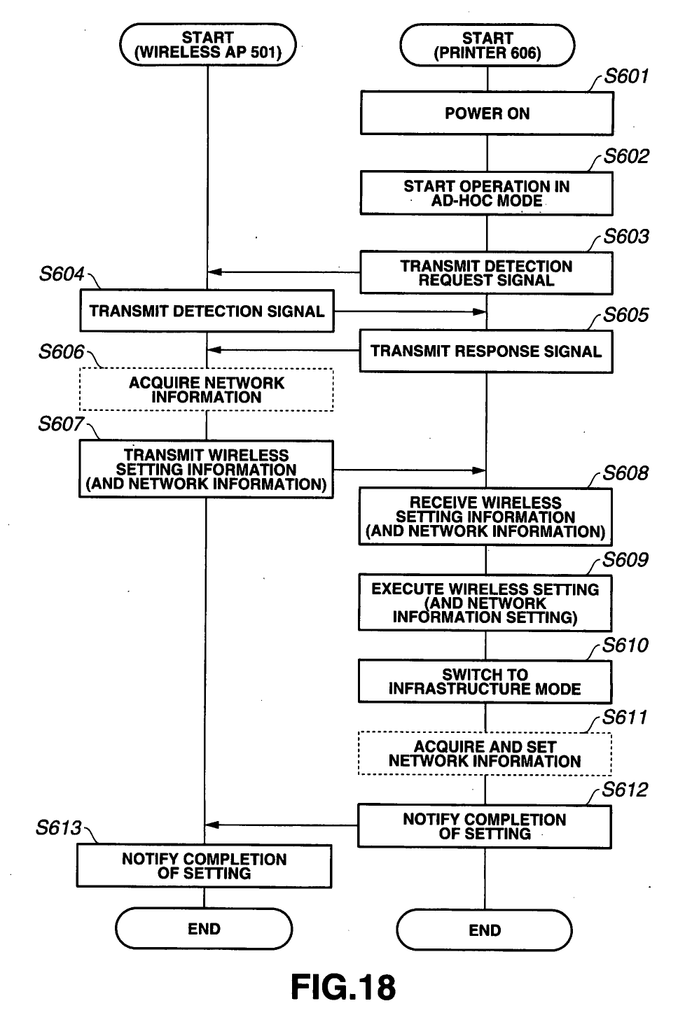

A description will be made of operation of the wireless AP 501 and the printer 606. FIG. 18 is a flowchart illustrating the flow of operations of the wireless AP 501 and the printer 606.

The wireless AP 501 and the printer 606 start operating when a person installing the printer 606 (the manager or user) installs the printer 606 in the vicinity of the wireless AP 501 (in a range capable of wireless communication) and turns on power to the printer 606 (S601).

When power is turned to the printer 606, the communication controller 660D causes the communication unit 662 to start wireless communications in the ad-hoc mode since no wireless setting information is stored in the setting storage portion 661B (S602). The detection request portion 660A firstly transmits a detection request signal (S603).

On the other hand, although operating in the infrastructure mode, the wireless AP 501 is able to receive the detection request signal transmitted in the ad-hoc mode. Upon receiving the detection request signal, the wireless AP 501 transmits a detection signal which is receivable in the ad-hoc mode (S604). This detection signal is similar to that in the exemplary embodiment 5 (as shown in FIG. 16B for example).

Upon the wireless AP 501 transmitting a detection signal, the communication controller 660D of the printer 606 receives the detection signal via the communication unit 662, and transmits a response signal to the wireless AP 501 (S605). This response signal is similar to that of the exemplary embodiment 1 (as shown in FIG. 5B, for example).

Upon the printer 606 transmitting a response signal to the wireless AP 501, the network information acquiring portion 510C of the wireless AP 501 acquires network information including an unused address from the manager PC 503 or the management server 504 (S606). The manager is required to enter network information through the manager PC 503 when network information is to be acquired from the manager PC 503, whereas the management server 504 replies automatically when network information is to be acquired from the management server 504. However, when the DHCP server 502 is used without using the manager PC 503 or the management server 504, the processing of the step S606 is not necessary.

Subsequently, the setting information transmitter 510B of the wireless AP 501 transmits wireless setting information stored in the setting storage portion 511B to the printer 606 (S607). The wireless setting information is transmitted in a same manner as in the exemplary embodiment 1 (for example, transmitted as a signal having a structure as shown in FIG. 5C).

On the other hand, upon the setting information receiving portion 660B of the printer 606 receiving the wireless setting information via the communication unit 662 (S608), the setting portion 660C performs setting based on the received wireless setting information, and stores the wireless setting information in the setting storage portion 661B, while setting network information (S609). However, when the DHCP server 502 is used without using the manager PC 503 or the management server 504, the setting of network information is not performed.

The communication controller 660D of the printer 606 then switches the wireless communications performed by the communication unit 662 from the ad-hoc mode to the infrastructure mode (S610), and the printer 606 performs communication with the DHCP server 502 via the wireless AP 501 to acquire and set network information such as an address (S611). However, when the manager PC 503 and the management server 504 are used without using the DHCP server 502, the processing of the step S611 is not necessary.

Subsequently, the printer 606 notifies the wireless AP 501 of completion of the setting as an apparatus connected on the network 505 (S612), and terminates the setting processing.

Upon being notified of the completion of the setting by the printer 606, the wireless AP 501 acknowledges the notification (S613), and terminates the setting processing. At the same time, the wireless AP 501 may notify the manager that the completion of setting has been notified by the printer 606.

When a printer that has been connected and used on a different network is installed as the printer 606, the wireless setting information can be changed by performing the processing as described above after initializing the setting of the printer 606 to delete the wireless setting information stored in the setting storage portion 661B.

The printer 606 described above may be configured to have a separate communication apparatus as described in the exemplary embodiment 2. Since such variation is conceivable to those skilled in the art, detailed description thereof will be omitted.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modification as suited to the particular use contemplated. It is intended that the scope of the invention be defined by the following claims and their equivalents.

What is claimed is:

1. A wireless communication system comprising a first wireless communication apparatus and a second wireless communication apparatus that perform communications in a first communication method in which preset setting information is used and in a second communication method in which the setting information is not used,
the first wireless communication apparatus comprising:
a communication unit that performs wireless communications in the first and second communication methods;
a storage unit that stores the setting information;
a detector that detects the second wireless communication apparatus by causing the communication unit to perform wireless communications in the second communication method; and
a transmitter that transmits the setting information stored in the storage unit to the second wireless communication apparatus by causing the communication unit to perform wireless communications in the second communication method, and
the second wireless communication apparatus comprising:
a communication unit that performs wireless communications in the first and second communication methods;
a receiver that receives setting information from the first wireless communication apparatus by causing the communication unit to perform wireless communications in the second communication method; and
a setting unit that sets the setting information received by the receiver as setting information used for communication by the first communication method.

2. A wireless communication system comprising a base station, and a wireless communication apparatus performing wireless communications with the base station, wherein
the wireless communication apparatus comprises:
a communication unit that performs wireless communications with the base station and wireless communications between apparatuses without involving the base station;
a storage unit that stores setting information used by the communication unit for wireless communications with the base station;
a detector that detects whether of not there is a communicable object apparatus in a range where the communication unit is able to perform wireless communications between apparatuses; and
a transmitter that transmits the setting information stored in the storage unit to the object apparatus detected by the detector via the communication unit.

3. A wireless communication apparatus comprising:
a communication unit that performs wireless communications in a first communication method in which communications are performed using preset setting information and in a second communication method in which communications are performed without using the setting information;
a storage unit that stores the setting information;
a detector that detects an object apparatus capable of wireless communications in the second communication method by causing the communication unit to perform the wireless communications in the second communication method; and
a transmitter that transmits the setting information stored in the storage unit to the object apparatus detected by the detector by causing the communication unit to perform wireless communications in the second communication method.

4. The wireless communication apparatus according to claim 3, further comprising an acquisition unit that acquires network information to be set in the object apparatus detected by the detector, wherein
the transmitter transmits the network information acquired by the acquisition unit to the object apparatus together with the setting information.

5. A wireless communication apparatus comprising:
a communication unit that performs wireless communications with a base station and wireless communications between apparatuses without involving the base station;
a storage unit that stores setting information used by the communication unit for wireless communications with the base station;
a detector that detects whether of not there is a communicable object apparatus in a range where the communication unit is able to perform wireless communications between apparatuses; and
a transmitter that transmits setting information stored in the storage unit to the object apparatus detected by the detector via the communication unit.

6. A wireless communication apparatus comprising:
a communication unit that performs wireless communications with a base station and wireless communications between apparatuses without involving the base station;
a storage unit that stores setting information used by the communication unit for wireless communications with the base station;
an acquisition unit that acquires network information from a network including the base station through the wireless communications with the base station performed by the communication unit;
a detector that detects whether of not there is a communicable object apparatus in a range where the communication unit is able to perform wireless communications between apparatuses; and
a transmitter that transmits the setting information stored in the storage unit and the network information acquired by the acquisition unit to the object apparatus detected by the detector through the communication unit.

7. A wireless communication apparatus comprising:
a communication unit that performs wireless communications in a first communication method in which communications are performed using preset setting information and in a second communication method in which communications are performed without using the setting information;
a receiver that receives setting information from an object apparatus capable of wireless communications in the second communication method by causing the communication unit to perform the wireless communications in the second communication method; and
a setting unit that sets the setting information received by the receiver as setting information to be used in the first communication method.

8. A wireless communication apparatus comprising:
a communication unit that performs wireless communications with a base station and wireless communications between apparatuses without involving the base station;
a receiver that receives setting information to be used by the communication unit for the wireless communications with the base station, through the wireless communications between apparatuses performed by the communication unit; and
a setting unit that sets the setting information received by the receiver.

9. A wireless communication apparatus comprising:
a communication unit that performs wireless communications with a base station and wireless communications between apparatuses without involving the base station;
a receiver that receives setting information to be used by the communication unit for the wireless communications with the base station and network information of a network including the base station, through the wireless communications between apparatuses performed by the communication unit; and
a setting unit that sets the setting information and the network information received by the receiver.

10. A wireless communication apparatus comprising:
a communication unit that performs wireless communications in a first communication method in which communications are performed using preset setting information and in a second communication method in which communications are performed without using the setting information;
a determination unit that determines whether or not the storage unit stores setting information to be used by the communication unit for the wireless communications in the first communication method; and
a controller controlling the communication unit to start the wireless communications in the second communication method when the determination unit determines that the storage unit does not store the setting information.

11. A wireless communication apparatus comprising:
a communication unit that performs wireless communications with a base station and wireless communications between apparatuses without involving the base station;
a determination unit that determines whether or not the storage unit stores setting information to be used by the communication unit for the wireless communications with the base station; and
a controller that controls the communication unit to start the wireless communications between apparatuses when the determination unit determines that the storage unit does not store the setting information.

12. A computer readable medium storing a program causing a computer to execute a process for setting wireless setting information, the process comprising:
causing a communication unit that performs wireless communications in a first communication method in which communications are performed using preset setting information and in a second communication method in which communications are performed without using the setting information to perform the wireless communications in the second communication method to detect an object apparatus capable of the wireless communications in the second communication method; and
causing the communication unit to perform the wireless communications in the second communication method to transmit the setting information stored by a storage unit to the detected object apparatus.

13. A computer readable medium according to claim 12, the process further comprising:
causing the computer to perform acquisition processing of acquiring network information to be set in the detected object apparatus,
the network information acquired in the acquisition processing being transmitted together with the setting information to the object apparatus in the transmission processing.

14. A computer readable medium storing a program causing a computer to execute a process for setting wireless setting information, the process comprising:
causing a communication unit that performs wireless communications with a base station and wireless communications between apparatuses without involving the base station to perform the wireless communications with the apparatuses to detect whether or not there is a communicable object apparatus; and
causing the communication unit to perform the wireless communications with the apparatuses to transmit setting information to be used by the communication unit for the communication with the base station, to the detected object apparatus.

15. A computer readable medium storing a program causing a computer to execute a process for setting wireless setting information, the process comprising:
causing a communication unit that performs wireless communications with a base station and wireless communications between apparatuses without involving the base station to perform the wireless communications with the apparatuses to detect whether or not there is a communicable object apparatus;
causing the communication unit to perform the wireless communications with the base station to acquire network information from a network including the base station; and
causing the communication unit to perform the wireless communications with the apparatuses to transmit setting information to be used by the communication unit for the communication with the base station, to the detected object apparatus.

16. A computer readable medium storing a program causing a computer to execute a process for setting wireless setting information, the process comprising:
causing a communication unit that performs wireless communications in a first communication method in which communications are performed using preset setting information and in a second communication method in which communications are performed without using the setting information to perform the wireless communications in the second communication method to receive setting information from an object apparatus capable of the wireless communications in the second communication method; and
setting the received setting information as setting information to be used for the communications in the first communication method.

17. A computer readable medium storing a program causing a computer to execute a process for setting wireless setting information, the process comprising:
causing a communication unit that performs wireless communications with a base station and wireless communications between apparatuses without involving the base station to perform the wireless communications with the apparatuses to receive setting information to be used by the communication unit for the wireless communications with the base station from a communicable object apparatus; and
setting the received setting information.

18. A computer readable medium storing a program causing a computer to execute a process for setting wireless setting information, the process comprising:
causing a communication unit that performs wireless communications with a base station and wireless communications between apparatuses without involving the base station to perform the wireless communications with the apparatuses to receive, from a communicable object apparatus, setting information used by the communication unit for the wireless communications with the base station and network information of a network including the base station; and
setting the received setting information and the network information.

19. A computer readable medium storing a program causing a computer to execute a process for setting wireless setting information, the process comprising:
determining whether or not a storage unit stores setting information to be used by a communication unit for wireless communications in a first communication method; and
controlling the communication unit to start wireless communications in a second communication method when it is determined that the storage unit does not store the setting information.

20. A computer readable medium storing a program causing a computer to execute a process for setting wireless setting information, the process comprising:
determining whether or not a storage unit stores setting information to be used by a communication unit for wireless communications with a base station; and
controlling the communication unit to start wireless communications between apparatuses when it is determined that the storage unit does not store the setting information.
